(19) United States
(12) Patent Application Publication
(10) Pub. No.: US 2016/0188470 A1
(43) Pub. Date: Jun. 30, 2016

(54) PROMOTION OF A CACHE LINE SHARER TO CACHE LINE OWNER

(71) Applicant: Arteris, Inc., Campbell, CA (US)

(72) Inventors: David A. Kruckemyer, San Jose, CA (US); Craig Stephen Forrest, San Francisco, CA (US)

(21) Appl. No.: 14/587,465

(22) Filed: Dec. 31, 2014

(51) Int. Cl. G06F 12/08

(52) U.S. Cl. CPC G06F 12/0815; G06F 2212/1032; G06F 2212/621

(57) ABSTRACT

A system and method for performing coherent cache snoops whereby a single or limited number of sharing coherent agents are snooped for a data access. A directory may store information identifying which coherent agents have a shared copy of a cache line. If more than one might be in a shared state, one is promoted to an owner state within the directory. Accesses to the shared cache line are responded to by a snoop to just one, or a number less than all, of the caching agents sharing the cache line.

### FIELD OF THE INVENTION

The invention is directed to computer processors and, more particularly, to systems on a chip with cache coherent multi-processors.

### BACKGROUND

The invention is applicable to many coherent caching protocols, but a MOESI protocol is exemplary. In a conventional directory-based system that implements a MOESI protocol, when a cache line is present in a caching agent, a directory assigns a directory-owned (DO) state to the caching agent (CA) for that cache line only when the CA has the exclusive copy of the cache line or has the cache line in a dirty state or the CA has indicated that it wants to write to the cache line. If none of these is true, but the CA has a valid copy, the directory assigns a directory-shared (DS) state to the CA. DS is a state in which a CA possesses a copy of the cache line, but does not indicate that it is dirty.

A directory may store a cache line entry for each cache line in the cache of each CA. Each cache line entry stores a cache line tag, among other information. Each cache line entry also stores an indication of which CAs are sharers of a line and, if the cache line is owned by a CA (i.e. in the M, O, or E state in the CA's cache), which CA is the owner.

If a line is shared, a request for that line (from a CA or an IO-coherent agent) will cause either a memory access or a broadcast snoop to all sharers. In some embodiments, a broadcast snoop would be sent to all CAs, but in others snoops are sent only to sharer CAs.

Every snoop and every memory access consumes bandwidth, potentially delaying other operations in the system. Every snoop and every memory access consumes power, which reduces battery life, and increases power delivery and cooling requirements for the system. Therefore, what is needed is a system and method that decreases power and bandwidth consumption, as well as provide other benefits, through reducing the number of snoops or memory accesses that are needed by using a directory-based approach based on coherence between the caches of multiple caching agents.

### SUMMARY OF THE INVENTION

The invention is directed to a directory-based system for coherence between the caches of multiple caching agents, and the method of operation of such a system. According to an aspect of the invention, for clean lines that might be present in multiple caches the directory tracks one cache, or none, as the owner of the line. When the directory receives a request for the line—the request requires a snoop—the directory snoops only the owner, or at least a limited number of caching agents in which the line might be present. By so doing, the number of snoops and the corresponding bandwidth and power consumption are reduced.

According to various aspects and some embodiments of the invention, the directory also tracks a number of caching agents as sharers of the clean line. These are the caching agents that are candidates for selection as the owner. According to various aspects and some embodiments, when a caching agent performs a write-back and does not keep a copy of the line, it is removed from the list of sharers and thereby becomes ineligible for promotion as the owner.

### BRIEF DESCRIPTION OF THE DRAWINGS

FIG. 1 shows a system of two caching agents (CAs) and a directory in accordance with the various aspects of the invention.

FIG. 2 shows a system of two CAs, another coherent agent, and a directory in accordance with the various aspects of the invention.

FIG. 3 shows a coherency transaction flow in which a coherent request causes a memory access in accordance with the various aspects of the invention.

FIG. 4 shows a coherency transaction flow in which a coherent request causes an access to each of two sharers in accordance with the various aspects of the invention.

FIG. 5 shows a coherency transaction flow, according to the invention, in which a coherency request causes an access to exactly one of two sharers in accordance with the various aspects of the invention.

FIG. 6 shows a flow chart for an access to a cached cache line in accordance with the various aspects of the invention.

### DETAILED DESCRIPTION

The invention is directed to selecting a set of cache line sharer caching agents (CAs) to snoop when no CA owns the line. The set is less than the total number of CAs in the system and the scope of the invention is not limited by the number of CA in the system. In accordance with the various aspects of the invention and in some embodiments, the set is all CAs are in a DS state. In accordance with some aspects and embodiment, the set is exactly one CA. In accordance with some aspects and embodiment, the set of CAs to snoop is multiple, but not all, sharer CAs.

According to some aspects and embodiments of the invention, in the case that the entry indicates that there is more than one cache line sharer, and there is no owner, the directory selects one CA to be the owner of the cache line. This is cache line sharer promotion. As a result, to provide data for a read request of the cache line, the system directory issues just one coherence operation to the CA that the directory promoted to a cache line owner. Effective operation of the invention—as well as the scope—does not require CAs to have any knowledge of ownership when they have a cache line in the shared state. The ownership state need only be determined in the directory.

By using cache line sharer promotion, less snoop bandwidth is consumed and less power is consumed. The benefit to bandwidth and power consumption is greater the more a workload causes sharing. In other words, multi-processor tasks that share a lot of data will see a great improvement with use of this invention.

In accordance with the aspects of the invention, different embodiments of the invention use different policies for choosing the sharing CA to promote to owner. Some aspects and embodiments of the invention do so based on bandwidth consumption, and in particular with a goal of distributing bandwidth. Some aspects and embodiments of the invention, implementing heterogeneous systems, favor one CA over another because of its attributes. One such attribute is available bandwidth. Another is the functions of CAs. However, the scope of the invention is not limited by the attribute selected. In accordance with the aspects of the invention, promotion favors the CA with the greatest available bandwidth. For example, in an ARM big.LITTLE system, the big CA might be a preferred choice because it has more hardware bandwidth or the LITTLE might be a preferred choice because it uses less bandwidth. In accordance with the aspects of the invention, some embodiments choose a CA based on prediction according to any number of heuristics. In accordance with the aspects of the invention, some embodiments choose a CA based on their power states; some embodiments choose a CA based on knowing whether they will respond to a snoop when they are in a DS state. The AMBA AXI Coherent Extensions (ACE) protocol, for example, recommends that CAs respond in the S state while other protocols recommend that CAs do not respond when they are in the S state.

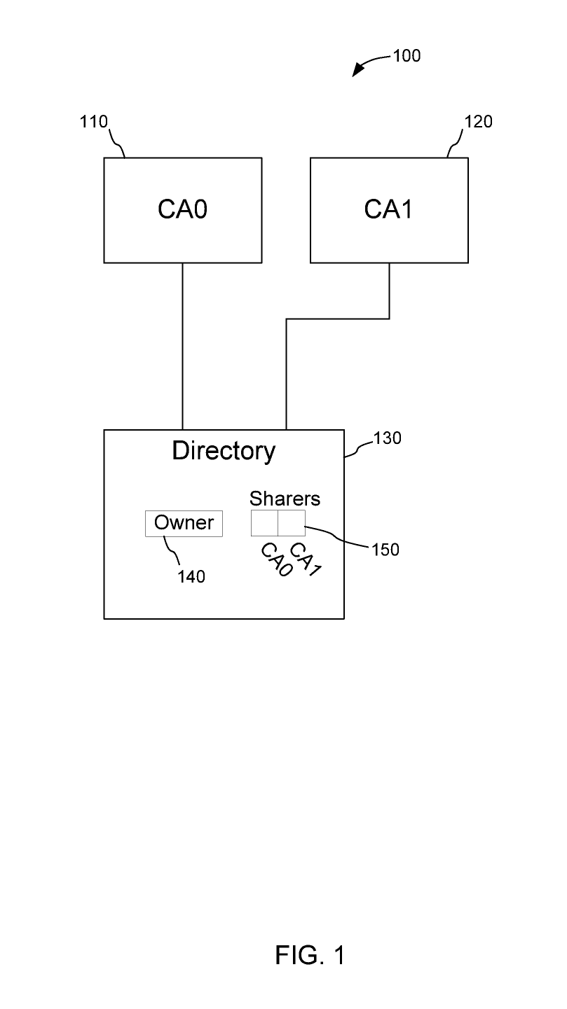

Referring now to FIG. 1, in accordance with the aspects of the invention, a coherent system 100 can include as few as two CAs, as shown. The system 100 includes CA0 110 and CA1 120, both in communication with a directory 130. The directory 130 stores an array of cache tag entries. Each cache tag entry includes and stores a field 140 that indicates the cache line owner, if there is one. Each cache tag entry also includes and stores a field 150 that indicates, for each CA, whether it is a sharer of the cache line.

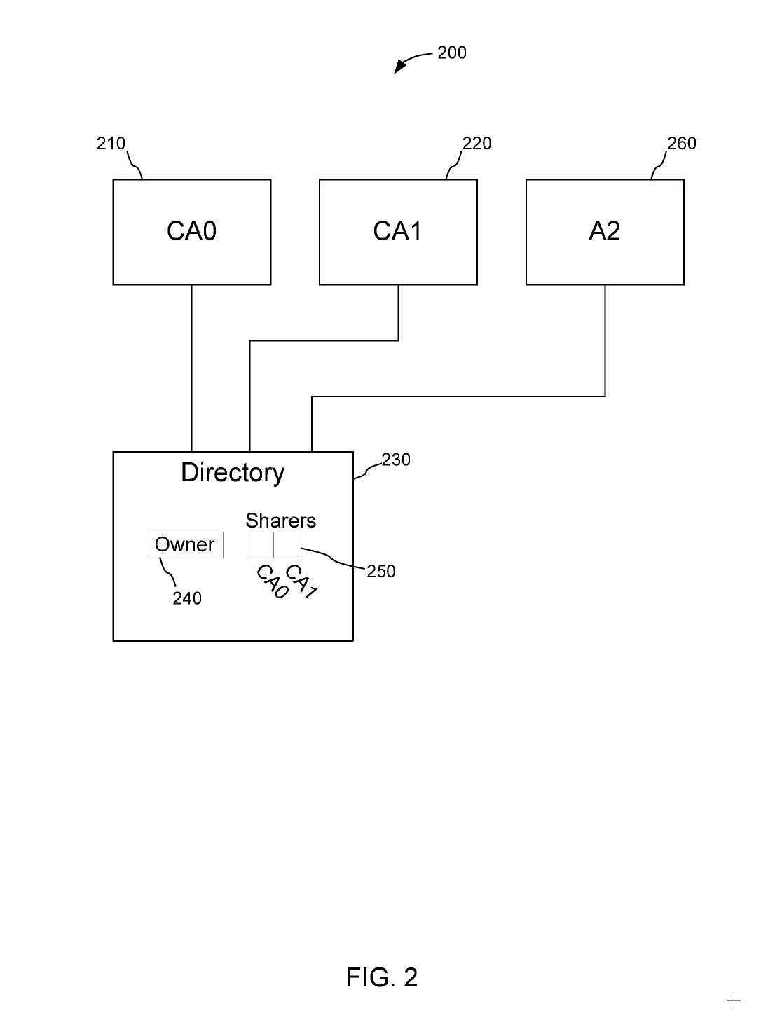

Referring now to FIG. 2, in accordance with the aspects of the invention, a system 200 is shown. The system 200 includes three agents: CA0 210, CA1 220, and coherent agent A2 260. All are in communication with a directory 230. The directory 230 includes and stores an array of cache tag entries. Each cache tag entry includes and stores a field 240 that indicates the cache line owner if there is one. Each cache tag entry also includes and stores a field 250 that indicates, for each CA, whether it is a sharer of the cache line.

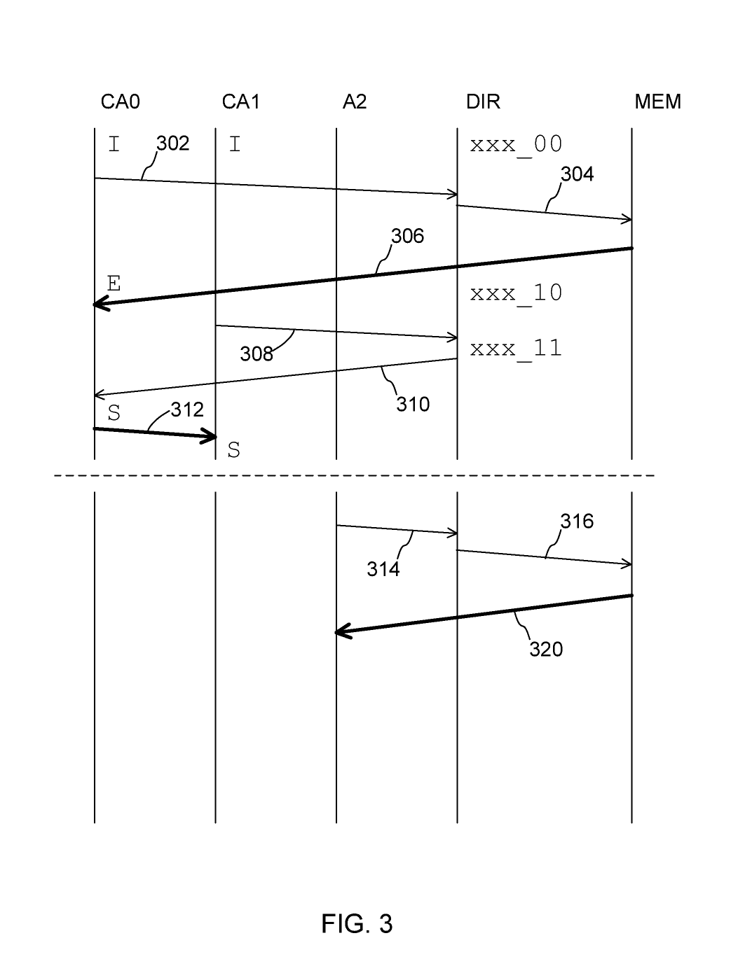

Referring now to FIG. 2 along with FIG. 3, in accordance with the aspects of the invention, transaction sequence in the system 200 of FIG. 2 is shown in FIG. 3. Transactions include requests and responses and as well as addresses. All caching agents are initialized with the cache line set to invalid (I) state. The directory is initialized to indicate no owner (xxx) and no sharers (sharer flags 00). CA0 210 makes read request 302 to the directory 203 (DIR), which in turn makes request 304 to memory (MEM). Memory sends response 306 to CA0 210, which enters the exclusive (E) state. CA1 220 makes a read request 308 to DIR, which changes CA0 210 to a sharer and marks CA1 220 as a sharer and sends data transfer snoop request 310 to CA0 210. CA0 210 enters the share (S) state (DS state in the directory) and performs data transfer 312 to CA1 220. In accordance with some aspects of the invention, in some embodiments CA1 220 modifies the cache line before snoop request 310 and assumes Owner (O) state (DO state in the directory 230) for the cache line after snoop request 310, but in any such embodiment, CA1 220 eventually returns to S state (DS state in the directory 230), such as due to a write back of the cache line. That leaves the system 200 in a state such that CA0 210 and CA1 220 are each designated sharers in the directory 230.

One transaction sequence, coherent agent A2 260 sends request 314 to DIR. DIR, in turn sends read request 316 to MEM. MEM provides read data response 320. Because this transaction sequence performs a memory access, even when the data is present in caches, it is unnecessarily expensive in performance and power consumption.

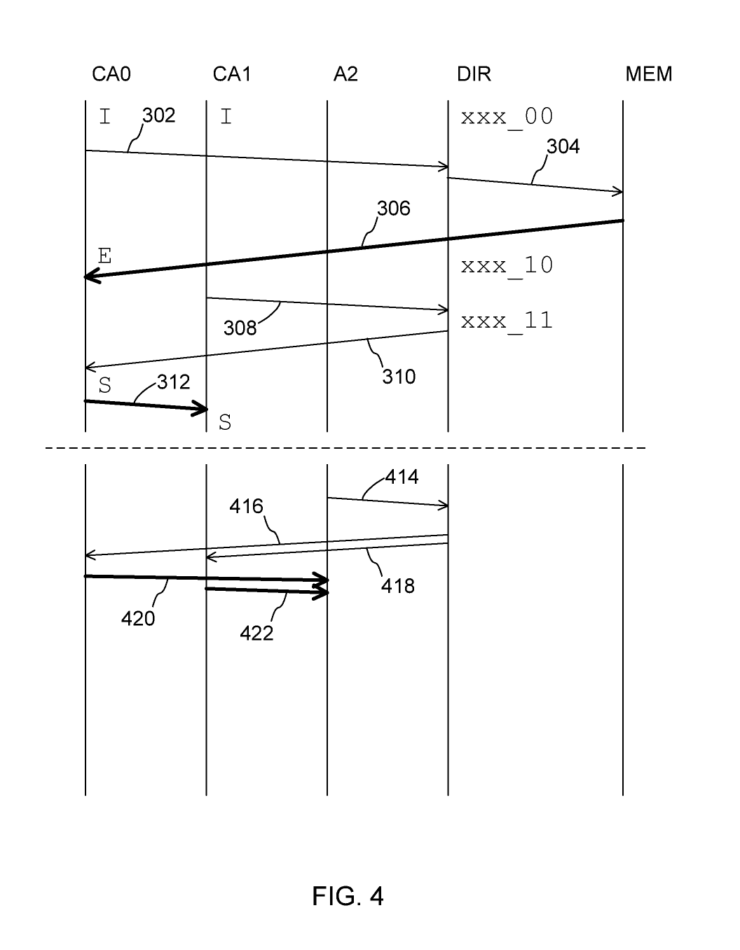

Referring further to FIG. 2, FIG. 3 and now FIG. 4, another transaction sequence is shown. The same transaction sequence shown in FIG. 3 occurs up until data transfer 312, at which point both CA0 210 and CA1 220 are holding the cache line in the S state. Agent A2 260 sends request 414 to DIR. DIR broadcasts snoops 416 and 418 to each of CA0 210 and CA1 220, respectively. CA0 210 and CA1 220 each respond, providing data to agent A2 260. Because this transaction sequence performs multiple snoops, it consumes snoop bandwidth unnecessarily. Furthermore, because it solicits the passing of redundant data from CA0 210 to A2 260 and CA1 220 to A2 260, it wastes snoop response bandwidth and significant power.

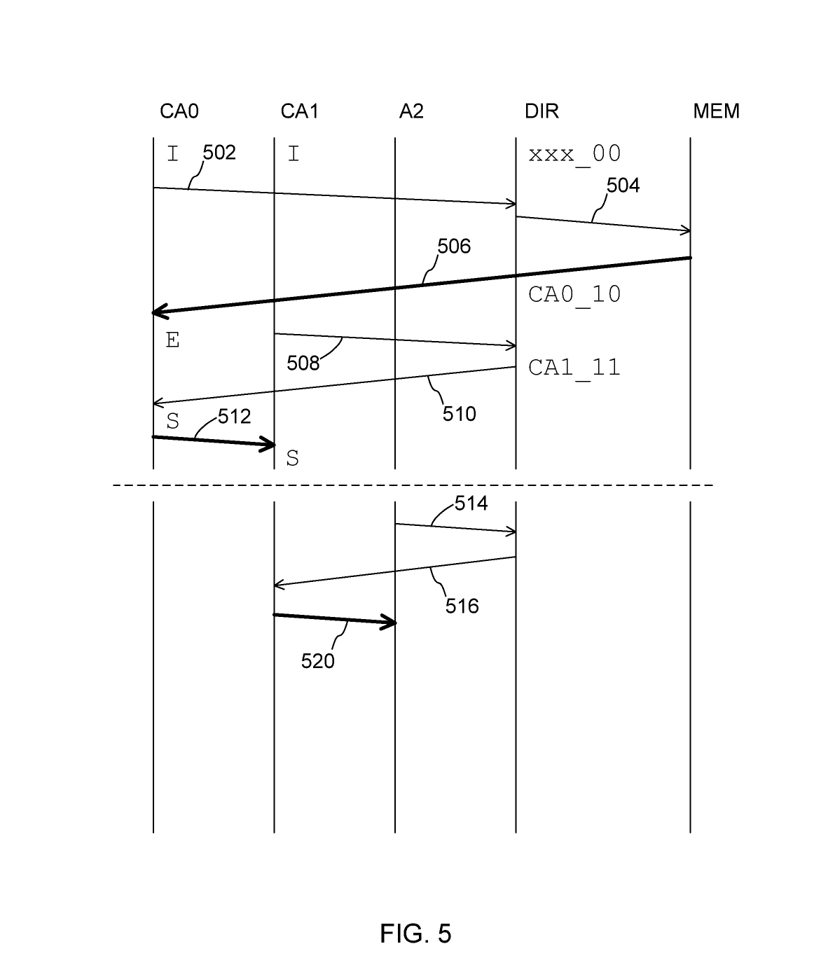

Referring again to FIG. 2 and now FIG. 5, in accordance with the various aspects of the invention, a transaction sequence in the system of FIG. 2, according to an embodiment of the invention is shown in FIG. 5. All caching agents are initialized with the cache line invalid (I) state. The directory 230 is initialized to indicate no owner (xxx) and no sharing (sharer flags 00). CA0 210 makes read request 502 to the directory 230 (DIR), which in turn makes request 504 to memory (MEM). MEM sends response 506 to CA0 210, which enters the exclusive (E) state, and DIR marks CA0 210 as a sharer (S) and as an owner (O) of the line (DO state). CA1 230 makes read request 508 to DIR, which marks CA1 230 as a sharer and as the owner (DO state), and sends data transfer snoop request 510 to CA0 210. CA0 210 enters the S state (DS state in the directory 230) and performs data transfer 512 to CA1. CA1 eventually returns to DS state. That leaves the system 200 in a state such that CA0 210 and CA1 230 are each a sharer in the directory 230, but DIR indicates CA1 230 as the owner.

Agent A2 260 sends request 514 to DIR. According to some aspects and an embodiment of the invention, DIR sends snoop request 516 to CA1 230 and only to CA1 230 because DIR indicates that CA1 230 is the cache line owner. CA1 230 completes the transaction and sequence by sending data to agent A2 260. This minimizes the number of snoops and the number of data transfers required, and makes use of data present in caches rather than accessing memory. In accordance with some aspects and some embodiments of the invention, a sharer is promoted to owner whenever a write-back occurs.

By snooping one caching agent instead of multiple sharers there is a lower probability that the snooping process will find the line, since it might have been invalidated in the snooped cache. In that case, a snoop to another sharer or a memory read is necessary, but will have been delayed. This performance loss can be alleviated with a scheme in which caching agents inform the directory when they have invalidate lines.

Alternatively, in accordance with other aspects of the invention, this performance loss can be minimized by snooping some number of sharer CAs, the number being greater than one but less than all sharers. The scope of the invention is not limited by the number of CAs that are snooped. Multiple CAs may supply the requested cache line to the original agent that initiated the read command, and the original agent is prepared to receive multiple incoming cache lines for read request.

In accordance with the various aspects and some embodiments of the invention, the directory 230 (DIR) does not store information to identify which CAs are sharers. Instead, when the directory 230 receives a request for a cache line that is not owned, it chooses an owner. The owner is then used to source the cache line for any other requests until the owner relinquishes ownership.

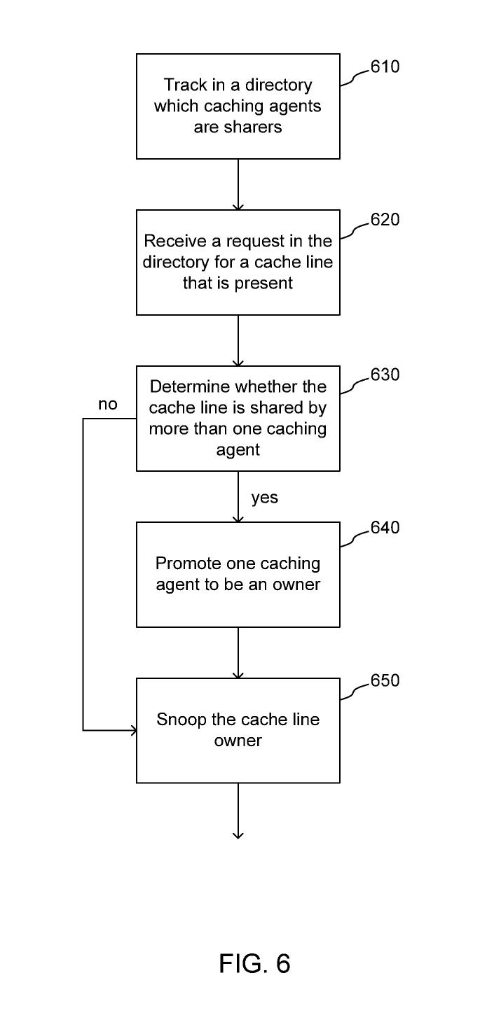

Referring now to FIG. 6, steps for accessing a cache line according to various aspects and an embodiment of the invention is shown. At step 610 a directory tracks which caching agents share a cache line. This step is an ongoing process during operation of the coherent system. At step 620, the directory receives a cache line request for a cache line that is present in at least one caching agent. At step 630, the directory determines whether the cache line is shared by more than one caching agent. If yes, then the process moves to step 640 and one of the sharing caching agents is promoted to be an owner. In that case, or if in step 630 it was determined that the caching line is not shared (only one caching agent has the cache line), then at step 650 the directory snoops the cache line owner.

As will be apparent to those of skill in the art upon reading this disclosure, each of the aspects described and illustrated herein has discrete components and features, which may be readily separated from or combined with the features and aspects to form embodiments, without departing from the scope or spirit of the invention. Any recited method can be carried out in the order of events recited or in any other order which is logically possible.

Unless defined otherwise, all technical and scientific terms used herein have the same meaning as commonly understood by one of ordinary skill in the art to which this invention belongs. Any methods and materials similar or equivalent to those described herein can also be used in the practice of the invention. Representative illustrative methods and materials are also described.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

In accordance with the teaching of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

The article of manufacture (e.g., computer or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Therefore, the scope of the invention, therefore, is not intended to be limited to the various aspects and embodiments discussed and described herein. Rather, the scope and spirit of invention is embodied by the appended claims.

What is claimed is:

1. A cache coherence system comprising:
a directory that receives requests for cache lines;
a first caching agent in communication with the directory; and
a second caching agent in communication with the directory,
wherein the directory is enabled to track at least one owner for a cache line and when both of the first caching agent and the second caching agent have a clean copy of the cache line, the directory promotes one of the first caching agent and the second caching agent to be an owner such that when the directory receives a request for the cache line the directory snoops the owner.

2. The cache coherent system of claim 1 further comprising a coherent agent, wherein when the coherent agent initiates a request, the directory snoops the owner.

3. The cache coherent system of claim 1 wherein the directory tracks whether a caching agent is a sharer.

4. The cache coherent system of claim 3 wherein, when a write-back happens, a caching agent is promoted.

5. A method of responding to a request for a cache line comprising the steps of:
receiving a request for the cache line in a directory;
determining whether the cache line is shared by more than one caching agent; and
if the cache line is shared by more than one caching agent, then promoting one caching agent to be a cache line owner, such that the request for the cache line is responded to by sending a snoop to the owner of the cache line.

6. The method of claim 5 wherein determining whether the cache line is shared by more than one caching agent includes tracking in the directory which of a plurality of caching agents is a sharer.

7. The method of claim 5 wherein determining whether the cache line is shared by more than one caching agent includes sending a snoop to each of a plurality of caching agents.

8. A non-transient computer readable medium storing hardware description language code that describes a cache coherence system includes a directory that, when a cache line is shared by a plurality of caching agents and no caching agent is an owner, promotes one caching agent to be an owner of the cache line.
